(19) United States
(12) Patent Application Publication
(10) Pub. No.: US 2011/0040434 A1
(43) Pub. Date: Feb. 17, 2011

(54) MOTORCYCLE

(75) Inventor: Kazuyoshi Kishibata, Numazu-shi (JP)

Correspondence Address: PEARNE & GORDON LLP, 1801 EAST 9TH STREET, SUITE 1200, CLEVELAND, OH, 44114-3108, US

(73) Assignee: Kokusan Denki Co., Ltd., Numazu-shi (JP)

(21) Appl. No.: 12/849,208

(22) Filed: Aug. 3, 2010

(30) Foreign Application Priority Data
Aug. 5, 2009 (JP) 2009-182421

(51) Int. Cl. B60W 10/08; B60W 20/00; B60W 10/06; B60W 10/02

(52) U.S. Cl. 701/22; 180/65.26; 903/902

(57) ABSTRACT

A motorcycle that transmits a rotation of an engine to a driving wheel via a power transmission device having a main clutch comprises a sub-clutch inserted between the power transmission device and an output shaft of the engine and a motor generator having a rotating shaft coupled to the power transmission device and is comprised so that the rotating shaft of the motor generator is coupled to the engine via the sub-clutch and to the driving wheel via the main clutch, and the motorcycle can be moved backward by turning off the sub-clutch and transmitting a rotation of the motor generator to the driving wheel via the main clutch.

### TECHNICAL FIELD

The present invention relates to a motorcycle that has an engine as a power source for running.

### BACKGROUND

A transmission of a motorcycle usually has no backward gear, so that a driver has to push a vehicle backward when the vehicle needs to be moved backward to turn the vehicle in a narrow space or put the vehicle into a garage, for example. A small motorcycle can be moved backward by man power because the vehicle weight is relatively light. However, a large motorcycle is hard to move backward by man power because the vehicle weight is very heavy. It may be barely possible to move the large motorcycle backward by man power on a flat ground, but it is almost impossible to move it backward on a slope and go up the slope.

A transmission of a large motorcycle may have a backward gear. However, if an engine is used as a power source for moving a vehicle backward, the vehicle can suddenly start moving backward despite the intention of a driver when the driver opens a throttle by mistake when the backward gear is engaged. Therefore, it is not preferred to provide the transmission with the backward gear and use the engine as a power source for moving the vehicle backward. Preferably, a motor is used as a power source for moving the motorcycle backward, and the power transmission from the engine to a driving wheel is disconnected when the motorcycle is moved backward.

As disclosed in Japanese Patent Application Laid-Open Publication Nos. 62-157882 and 2005-271669, motorcycles that use an engine starter motor as a power source for rotating the driving wheel in the backward direction are proposed.

These motorcycles are comprised so that a forward rotation of the motor is transmitted to a crankshaft via a first one-way clutch and a gear transmission mechanism when the engine is started, and a reverse rotation of the motor (a rotation in the reverse direction to that at the time of engine start) is transmitted to the driving wheel via a second one-way clutch and another gear transmission mechanism when the motorcycle is moved backward.

The conventional motorcycles that have a transmission provided with no backward gear and use a motor as a power source for moving the vehicle backward need to have two sets of a one-way clutch and a gear transmission mechanism in addition to the power transmission device that transmits the rotation of the engine to the driving wheel, because one set of a one-way clutch and a gear transmission mechanism is needed to transmit the forward rotation of the engine starter motor to the crankshaft of the engine, and another set of a one-way clutch and a gear transmission mechanism is needed to transmit the reverse rotation of the engine starter motor to the driving wheel. Therefore, the conventional motorcycles that use a motor as a power source for moving the vehicle backward have a problem that the engine is mechanically complicated and bulky.

In addition, in order to turn the motorcycle in a narrow space, the motorcycle has to be moved not only backward but also forward. Therefore, the motor used as a power source is preferably capable of moving the vehicle not only backward but also forward. However, the conventional motorcycles are comprised so that the reverse rotation of the motor is transmitted to the driving wheel via the one-way clutch, and therefore, the forward rotation of the motor cannot be transmitted to the driving wheel to move the vehicle forward.

### SUMMARY

An object of the present invention is to provide a motorcycle that can be safely moved backward using a motor as a power source without complicating the structure of an engine and increasing the size of the engine.

Another object of the present invention is to provide a motorcycle that can be safely moved forward and backward using a motor as a power source without complicating the structure of the engine and increasing the size of the engine.

The present invention is applied to a motorcycle comprising an engine, an engine controlling section that controls the engine, and a power transmission device that transmits a rotation of the engine to a driving wheel. In the motorcycle according to the present invention, the power transmission device has a main clutch turned on and off during running, and the engine controlling section is comprised so as to stop the engine when an engine stop command is provided thereto.

The main clutch is a clutch that turns on and off the power transmission from the engine to the driving wheel during running, and is typically turned off (disengaged) by grasping a clutch lever provided on a handle and turned on (engaged) by releasing the clutch lever.

According to the present application, the motorcycle further comprises a sub-clutch that is inserted between an output shaft of the engine and the power transmission device and is capable of being controlled to be on and off, a motor generator that is comprised of a dynamo electric machine functioning as a motor and a generator and has a rotating shaft coupled to the power transmission device in such a manner that power is transmitted between the motor generator and the engine via the sub-clutch and between the motor generator and the driving wheel via the main clutch, a mode selection switch that selects a normal operation mode that allows a normal operation using the engine as a power source, an engine stop mode, or an assist mode that allows an assisted operation using the motor generator as a power source, and a processor that performs a generation or cancellation of the engine stop command and a control of the sub-clutch and the motor generator according to the control mode selected by the mode selection switch.

The processor is configured to: (a) generate the engine stop command when the engine stop mode or the assist mode is selected and cancel the engine stop command when the normal operation mode is selected; (b) control the sub-clutch in such a manner that the sub-clutch is turned on when a mode other than the assist mode is selected and turned off when the assist mode is selected; and (c) perform an assisting motor control to control the motor generator to operate as a motor when the assist mode is selected.

According to the construction described above, when a mode other than the assist mode is selected, the sub-clutch is turned on, so that power can be transmitted between the motor generator and the engine. In this state, the engine can be started by controlling the motor generator to operate as a motor, and once the engine is started, the engine can drive the motor generator to operate as a generator to generate an electric power used for battery charging or other purposes.

When the assist mode is selected, the sub-clutch is turned off to disconnect the power transmission from the engine to the driving wheel, and then, the assisting motor control is performed to make the motor generator operate as a motor. Therefore, the rotation of the motor generator can be transmitted to the driving wheel independently of the rotation of the engine. Therefore, the motor generator can be used as a power source to move the vehicle forward and (or) backward, and even a heavy vehicle can be easily turned or put into a garage, for example.

In this specification, an operation of the motorcycle using the motor generator rather than the engine as a power source will be referred to as “assisted operation”, and a running of the motorcycle using the motor generator rather than the engine as a power source will be referred to as “assisted running”.

According to the present invention, since the power source other than the engine is used for the assisted running, the assisted running can be performed by a manipulation different from the manipulation to perform the normal operation. Therefore, the driver can consciously perform the assisted operation, and the vehicle can be prevented from suddenly moving backward despite the intention of the driver because of an erroneous operation. In general, the dynamo electric machine can be easily controlled to gradually increase the rotational speed to a preset speed, and this holds true for the motor generator. Therefore, by using the motor generator as a power source for the assisted running, the running speed during the assisted running can be easily set in a safe range (2 to 3 km/h, for example), and thus the safety is improved.

In addition, according to the present invention, simply adding the sub-clutch between the crankshaft of the engine and the power transmission device enables power transmission from the motor generator to the driving wheel, and there is no need to provide the conventional power transmission mechanism having a one-way clutch between the motor and the engine and a one-way clutch between the motor and the driving wheel, so that the construction of the power transmission device can be prevented from being complicated. In addition, since the motor generator that doubles as a motor and a generator is used as the dynamo electric machine, the engine can have a simple construction and a small size compared with the conventional motorcycle having an engine incorporating two dynamo electric machines, that is, a motor used for engine start and a generator used for battery changing.

According to the present invention, since the engine stop command is generated when a mode other than the normal operation mode is selected, the engine can be kept stopped when the assisted running is performed using the motor generator as a power source. Therefore, it is possible to prevent the vehicle from suddenly being driven by the engine to start running despite the intention of the driver when the sub-clutch is accidentally turned on because of an erroneous operation during the assisted running, and thus the safety is improved.

According to the construction described above, turn on and off of the sub-clutch occurs only when the engine is stopped, so that it is not necessary to consider a situation where the sub-clutch is used in a half-clutch position. Therefore, the sub-clutch can be a clutch that has a simple structure including no synchronization mechanism, and the cost increase due to the addition of the sub-clutch can be minimized.

### BRIEF DESCRIPTION OF THE DRAWINGS

FIG. 1 is a front view of an exemplary motorcycle;

FIG. 2 is a top view of a handle section of the motorcycle;

FIG. 3 is a schematic diagram showing a configuration of a power transmission device according to an embodiment of the present invention;

FIG. 4 is a front view of an example of a kill switch and an engine starter switch provided on a handle of the motorcycle;

FIG. 5 is a block diagram showing a construction of an electronic control unit used in the embodiment of the present invention;

FIG. 6 is a block diagram showing an exemplary construction of a controller used in the embodiment of the present invention;

FIG. 7 is a block diagram for illustrating transition conditions on which the controller causes a transition of a control mode according to the embodiment of the present invention;

FIG. 8 is a block diagram for illustrating transitions of the control mode of a motor generator during an assisted operation according to the embodiment of the present invention;

FIG. 9 is a block diagram for illustrating transition conditions on which the controller causes a transition of the control mode according to another embodiment of the present invention;

FIG. 10 is a flowchart for illustrating an algorithm of a processing performed by a computer when the controller is activated according to the embodiment of the present invention;

FIG. 11 is a flowchart for illustrating an exemplary algorithm of a processing performed by the computer when a normal operation mode is selected according to the embodiment of the present invention;

FIG. 12 is a flowchart for illustrating an exemplary algorithm of a processing performed by the computer to control a sub-clutch according to the embodiment of the present invention;

FIG. 13 is a flowchart for illustrating an exemplary algorithm of a processing performed by the computer when a backward assist mode is selected according to the embodiment of the present invention;

FIG. 14 is a flowchart for illustrating an exemplary algorithm of a processing performed by the computer when a forward assist mode is selected according to the embodiment of the present invention;

FIG. 15 is a flowchart illustrating an exemplary algorithm of a processing performed by the computer when an engine stop mode is selected according to another embodiment of the present invention; and

FIG. 16 is a graph showing control characteristics of a rotational speed of the motor generator operating as a motor according to the embodiment of the present invention.

### DETAILED DESCRIPTION

In the following, embodiments of the present invention will be described in detail with reference to the drawings.

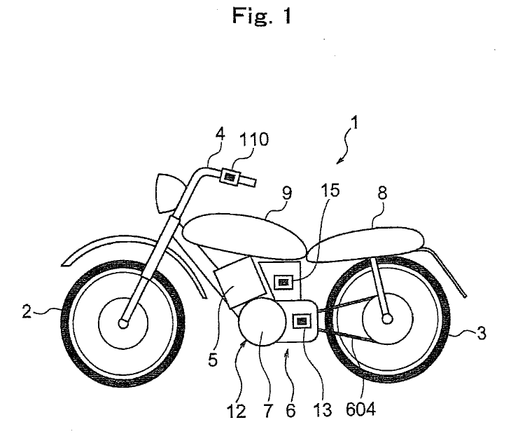

FIG. 1 shows an example of a motorcycle 1 that has an engine as a power source. As shown in this drawing, the motorcycle 1 comprises a steering wheel (front wheel) 2, a driving wheel (rear wheel) 3, a handle 4 attached to the steering wheel 2, an engine 5 that runs under the control of an engine controlling section, a power transmission device 6 that transmits an output power of the engine 5 to the driving wheel 3, and a motor generator (MG) 7 coupled to the engine 5 and the driving wheel 3 via the power transmission device 6. A reference numeral 8 denotes a seat on which a driver sits, and 9 denotes a fuel tank.

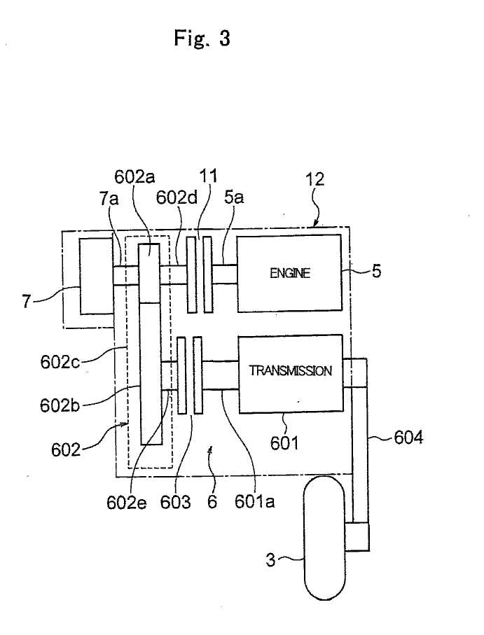

As shown in FIG. 3, the power transmission device 6 comprises a transmission 601, an engine-side power transmission mechanism 602 that transmits the output power of the engine 5 to the transmission, a main clutch 603 inserted between the transmission and the engine-side power transmission mechanism 602, and the driving-wheel-side power transmission mechanism 604 that transmits a rotation of an output shaft of the transmission 601 to the driving wheel 3.

In this embodiment, a sub-clutch 11 that can be electrically controlled to be on and off is inserted between an output shaft (crankshaft) 5a of the engine 5 and the power transmission device 602. In this embodiment, turn on or off of the sub-clutch 11 occurs only when the engine is stopped, so that it is not necessary to consider a situation where the sub-clutch 11 is used in a half-clutch position. Therefore, the sub-clutch 11 can be a clutch that has a simple structure including no synchronization mechanism. In this embodiment, the sub-clutch 11 is a dog clutch that is turned on and off by an electric actuator.

The engine-side power transmission mechanism 602 shown is comprised of a gear mechanism comprised of a small gear 602a and a large gear 602b for power transmission and a case 602c housing the gear mechanism, and the sub-clutch 11 is inserted between an input shaft 602d of the engine-side power transmission mechanism 602 (input shaft of the power transmission device) and the crankshaft 5a of the engine. The main clutch 603 is inserted between an output shaft 602e of the engine-side power transmission mechanism 602 attached to the large gear 602b and an input shaft 601a of the transmission 601. The engine 5, the transmission 601, the engine-side power transmission mechanism 602, the main clutch 603, and the sub-clutch 11 are housed in an engine case to form an engine block 12. The driving-wheel-side power transmission mechanism 604 shown is comprised of a chain and sprocket mechanism housed in a casing.

The motor generator 7 is comprised of a dynamo electric machine that functions as a motor and a generator. The motor generator 7 is used as a starter motor that triggers cranking of the engine to start the engine and used as a generator that generates an electric power to charge a battery during a normal operation when the engine is used as the power source. In addition, according to the present invention, the starter generator 7 is used as a power source for running in an assisted operation when the vehicle is moved backward and forward without using the engine as a power source.

As shown in FIG. 3, the motor generator 7 is mechanically coupled to the engine-side power transmission device 6. Thus, when the sub-clutch 11 is in the on state, the power can be transmitted between the engine 5 and the motor generator 7 via the sub-clutch 11, and when the main clutch 603 is in the on state, the power can be transmitted between the motor generator 7 and the driving wheel 3 via the main clutch 603. In the example shown in the drawings, a rotating shaft 7a of the motor generator 7 is directly coupled to the input shaft 602d of the engine-side power transmission mechanism 602.

The motor generator 7 may be coupled to the output shaft 602e of the engine-side power transmission mechanism 602 or may be coupled to the small gear 602a or large gear 602b of the engine-side power transmission mechanism 602 via a gear.

As described above, in this embodiment, the sub-clutch 11 is inserted between the engine 5 and the engine-side power transmission mechanism 602, and the rotating shaft of the motor generator 7 is coupled to the power transmission device 6 so that the power can be transmitted between the motor generator 7 and the engine 5 via the sub-clutch 11 in the both directions, and the power can be transmitted between the motor generator 7 and the driving wheel 3 via the main clutch 603.

According to the configuration, the power can be transmitted between the motor generator 7 and the engine 5 by turning on the sub-clutch 11, and the engine 5 can be started by setting the motor generator 7 to function as a motor in this state. Once the engine 5 is started, the engine 5 can drive the motor generator 7 to make the motor generator 7 to function as a generator and generate an electric power used for battery charging or other purposes.

On the other hand, if the sub-clutch 11 is turned off, the power transmission from the engine 5 to the driving wheel can be disconnected, so that the motor generator 7 can be set to function as a motor, and the rotation of the motor can be transmitted to the driving wheel 3. Thus, the motor generator 7 can be used as a power source to move the motorcycle backward and forward.

In this embodiment, in order to control the engine 5, the motor generator 7 and the sub-clutch 11, a gear position sensor 13 for detecting a gear position of the transmission 601 is attached to the engine block 12, and an electronic control unit (ECU) 15 is attached to a chassis section below the fuel tank 9, as shown in FIG. 1.

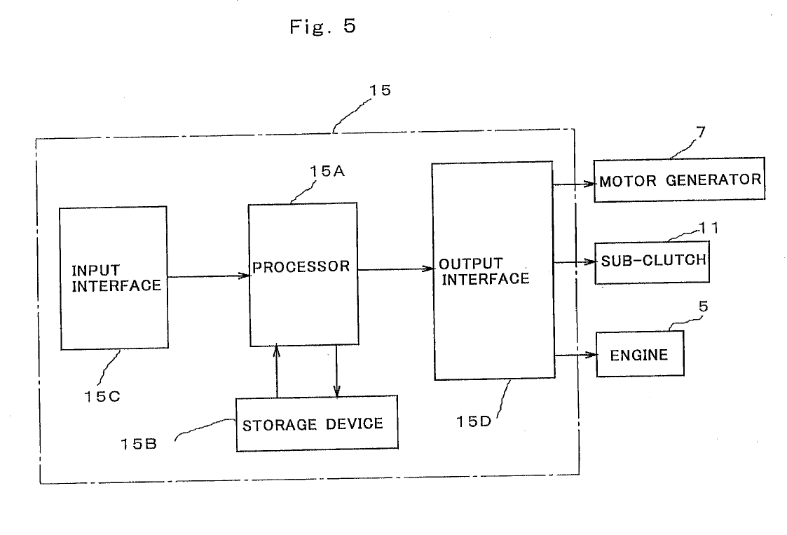

As shown in FIG. 5, the ECU 15 comprises a processor 15A, a storage device 15B, an input interface 15C that converts signals output from various sensors or detection switches into signals recognizable by the processor 15A, and an output interface 15D that converts a command signal output from the processor 15A for separately controlling the engine 5, the motor generator 7 and the sub-clutch 11 into a drive signal suitable for each control target. The processor 15A executes a predetermined program stored in the storage device 15b, thereby implementing the engine controlling section that performs a control required to run the engine 5 and a controller characteristically provided in the present invention.

The engine controlling section performs not only a control required to run the engine 5, such as controlling the ignition timing or fuel supply amount of the engine 5, but also a control to stop the engine in response to an engine stop command.

As described later, the controller controls generation and cancellation of an engine stop command and controls the sub-clutch 11 and the motor generator 7, depending on the control mode selected with a mode selection switch.

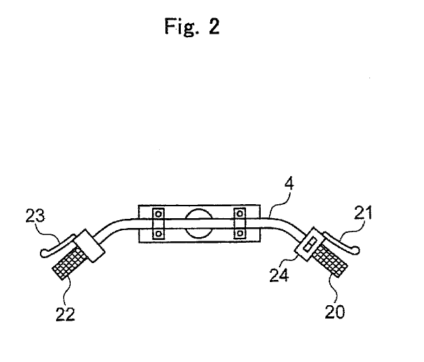

As shown in FIG. 2, the handle 4 has an accelerator grip 20 used for operating a throttle and a brake lever 21 attached to the right end thereof and a fixed grip 22 and a clutch lever 23 attached to the left end thereof. In addition, a switch panel 24 is attached to the right end of the handle 4 at a position adjacent to the accelerator grip 20.

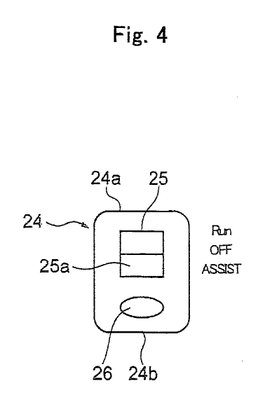

As shown in FIG. 4, the switch panel 24 includes a seesaw switch 25 that doubles as a kill switch and the mode selection switch and a push button switch 26 that doubles as an engine starter switch and a rotational direction switch. The kill switch is a switch manipulated to generate the engine stop command to forcedly stop the engine. The engine starter switch is a switch manipulated to generate an engine start command to start the engine, and the rotational direction switch is a switch manipulated to switch the rotational direction of the motor generator 7 that is operating as a motor in the assisted operation (between backward and forward directions).

The seesaw switch 25 shown is a three-pole three-position switch that has a seesaw-shaped switch knob 25a that pivots about a longitudinal center thereof. The switch can assume one of three positions, a first position in which the switch knob 25a is inclined toward one end 24a of the panel, a second position in which the switch knob 25a is parallel to the surface of the panel 24, and a third position in which the switch knob 25a is inclined toward another end 24b of the panel. The switch is comprised so as to switch from the first position to the third position via the second position and from the third position to the first position via the second position.

When the switch 25 is used as a kill switch, the first position allows start of the engine, and the positions other than the first position (the second position and the third position) are engine stop positions. More specifically, the engine can be started only when the switch knob 25a assumes the first position, and the engine is prohibited from rotating when the switch knob 25a assumes the second or third position.

In this embodiment, the controller has four control modes, a normal operation mode, an engine start mode, an engine stop mode, and an assist mode, and the mode selection switch and the engine starter switch are used to select from among these modes.

The mode selection switch may be a dedicated switch separately provided. However, in this embodiment, the switch 25 used as a kill switch is used as the mode selection switch.

When the switch 25 is used as the mode selection switch, the switch knob 25a assumes the first position to select the normal operation mode, assumes the second position to select the engine stop mode, and assumes the third position to select the assist mode. In order to select the engine start mode, the switch 25 is set in the first position to select the normal operation mode, and then the engine starter switch 26 is pushed.

“RUN”, “OFF” and “ASSIST” shown in FIG. 4 represent switch positions of the switch 25 used as the mode selection switch. More specifically, “RUN” represents the first position to select the normal operation mode, “OFF” represents the second position to select the engine stop mode, and “ASSIST” represents the third position to select the assist mode.

The seesaw switch 25 that doubles as the kill switch and the mode selection switch and the push button switch 26 that doubles as the engine starter switch (switch that is closed to start the engine) and the rotational direction switch are arranged side by side in the longitudinal direction on the switch panel 24 attached to the handle 4.

The motor generator 7 used in this embodiment is a well-known motor generator that comprises a rotor comprised of a rotor yoke and permanent magnets that form a magnetic field of a predetermined number of poles, a stator having armature coils for multiple phases, and a rotor position sensor that detects the rotational angle of the rotor with respect to the armature coil for each phase of the stator. As with a brushless motor, the motor generator 7 can operate as a motor to rotate the rotor in a predetermined direction by changing the combination pattern of the phases of the armature coils through which a driving current passes according to the position of the rotor appropriately detected by the rotor position sensor. In addition, the rotor can be made to rotate in both the forward and reverse direction by changing the polarity of the driving current passing through the armature coils and the combination pattern of the phases of the armature coils through which the driving current passes. The method of controlling the motor generator 7 to make the motor generator 7 operate as a motor is the same as the method of controlling a brushless motor.

Alternatively, if a power source is used to drive the rotor of the motor generator 7, the motor generator 7 can operate as a generator, and a multi-phase alternating current output power can be derived from the armature coils. The structure of the motor generator of this type and the method of controlling driving of the motor generator are known and disclosed in Japanese Patent Application Laid-Open Publication No. 2000-209891, for example.

The rotor position sensor that detects the position of the rotor of the motor generator 7 may be a Hall sensor or a resolver that detects the polarity of a magnetic pole of the rotor at a detection position determined with respect to the armature coil for each phase of the stator.

As described above, when the switch 25 is used as the mode selection switch, the mode selection switch 25 is set in the RUN position to select the normal operation mode, set in the OFF position to select the engine stop mode, and set in the ASSIST position to select the assist mode.

The normal operation mode is a mode that allows a normal operation in which the rotation of the engine 5 can be transmitted to the driving wheel 3 so that the engine 5 can be used as the power source, and the engine stop mode is a mode in which the engine is kept in a stopped state. The assist mode is a mode in which the rotation of the motor generator 7 can be transmitted to the driving wheel 3 so that the motor generator 7 can be used as the power source to achieve the assisted operation.

A program executed by the microprocessor 15A of the ECU 15 is comprised so as to implement not only the engine controlling section provided originally for controlling ignition, fuel supply or the like of the engine but also the controller that controls the sub-clutch 11 and the motor generator 7 and generates the engine stop command in response to the control mode selected by the mode selection switch 25.

The controller comprises engine stop command generating means that controls generation and cancellation of the engine stop command in such a manner that the engine stop command is generated when the modes other than the normal operation mode is selected, that is, when the engine stop mode or the assist mode is selected, and is cancelled when the normal operation mode is selected, sub-clutch controlling means that controls the sub-clutch in such a manner that the sub-clutch 11 is turned on when the modes other than the assist mode is selected and is turned off when the assist mode is selected, and motor generator controlling means that performs an engine starting motor control and an assisting motor control.

The engine starting motor control is a control to make the motor generator 7 operate as an engine starter motor when the mode selection switch 25 is set in the RUN position to select the normal operation mode, and then the engine starter switch 26 is pushed to issue the engine start command (that is, when the engine start mode is selected).

The assisting motor control is a control to make the motor generator 7 operate as a motor as a power source for the assisted running when the mode selection switch 25 is set in the ASSIST position to select the assist mode.

The program executed by the processor 15A of the ECU 15 is essentially comprised so as to perform control of generation and cancellation of the engine stop command in which the engine stop command is generated when the mode selection switch 25 selects the engine stop mode or the assist mode and is cancelled when the normal operation mode is selected, a sub-clutch control to turn off the sub-clutch 11 when the assist mode is selected, and an assisting motor control to make the motor generator operate as a motor when the assist mode is selected.

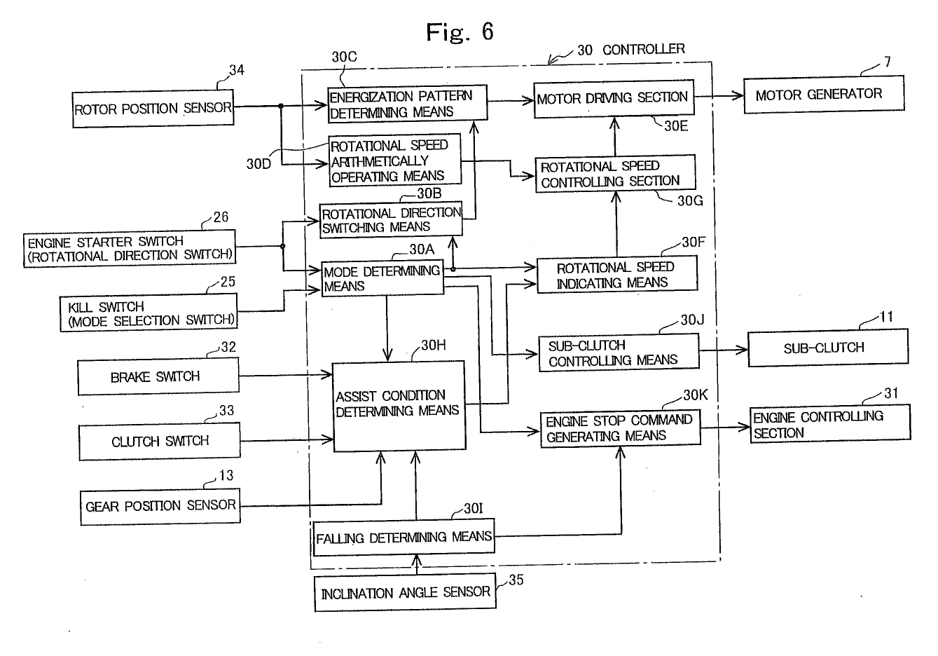

Although the program executed by the processor 15A is essentially comprised so as to perform the various control operations described above, the program executed by the processor 15A in this embodiment is comprised so as to implement a controller 30 having various function implementing means shown in FIG. 6.

In the example shown in FIG. 6, an engine start command generated by the engine starter switch 26, a signal generated by the mode selection switch 25, a detection signal generated by the gear position sensor 13, a brake operation detection signal from a brake switch 32, a clutch operation detection signal generated by the clutch switch 33, an output signal of a rotor position sensor 34 provided in the motor generator 7, and an output signal of an inclination angle sensor 35 that detects the inclination angle of the vehicle are input to the controller 30.

The brake switch 32 is attached to the handle 4 and generates the brake operation detection signal when the brake lever 21 is grasped. The brake switch 32 can be a conventional brake switch used to turn on a brake lamp.

The clutch switch 33 is also attached to the handle 4 and generates the clutch operation detection signal when the clutch lever 23 is grasped to disconnect the main clutch 603 (when the main clutch 603 is brought into the off state).

The gear position sensor 13 detects the gear position of the transmission 601 and generates a signal that indicates the position of a selected gear.

The inclination angle sensor 35 is comprised of an acceleration sensor or the like and generates a signal corresponding to the inclination angle of the vehicle. The controller 30 has falling determining means 30I that determines whether the vehicle has fallen or not based on the inclination angle of the vehicle detected by the inclination angle sensor 35, and the inclination angle sensor 35 and the falling determining means 30I forms falling detecting means that determines that the vehicle has fallen when a preset value of the inclination angle of the vehicle is exceeded.

The controller 30 shown in FIG. 6 has mode determining means 30A, and the engine start command generated by the engine starter switch 26 and the mode selection signal generated by the mode selection switch 25 are input to the mode determining means.

The mode determining means 30A determines that the control mode is the normal operation mode when the mode selection switch 25 is set in the RUN position, and determines that the control mode is the engine start mode when the mode selection switch 25 is set in the RUN position, and the engine starter switch 26 generates the engine start command (the push button switch 26 is pushed).

The mode determining means 30A determines that the control mode is the engine stop mode when the mode selection switch 25 is set in the OFF position and determines that the control mode is the assist mode when the mode selection switch 25 is set in the ASSIST position.

In this embodiment, the engine starter switch 26 serves also as the rotational direction switch that switches the rotational direction of the motor generator in the assisted operation between a first direction to move the motorcycle backward and a second direction to move the motorcycle forward. In this case, the controller 30 has rotational direction switching means 30B that switches a rotational direction command indicating the rotational direction each time the switch 26 is pushed during the assisted mode.

The controller 30 further has the rotational direction switching means 30B that generates a rotational direction indication value that indicates the rotational direction of the motor when the motor generator 7 operates as a motor, energization pattern determining means 30C that determines the combination pattern of the phases of the armature coils through which the driving current passes based on the position detection signal from the rotor position sensor 34 and the rotational direction indicated by the rotational direction indication value, rotational speed arithmetically operating means 30D that arithmetically operates the rotational speed of the motor generator from the output signal of the rotor position sensor 34, a motor driving section 30E that supplies the driving current to the motor generator 7, rotational speed indicating means 30F that indicates the rotational speed when the motor generator operates as a motor, and a rotational speed controlling section 30G that performs PWM control of the driving current supplied from the motor driving section 30E to the motor generator so as to make the rotational speed of the motor generator 7 agree with the rotational speed indicated by the rotational speed indicating means 30F.

More specifically, when the mode determining means 30A determines that the control mode is the engine start mode, the rotational direction switching means 30B sends a rotational direction indication signal indicating the rotational direction of the motor generator 7 as the rotational direction to start the engine to the energization pattern determining means 30C. In addition, when the mode determining means 30A determines that the control mode is the assist mode, the rotational direction switching means 30B assumes the rotational direction at the time of selection of the assist mode as a first direction (backward direction) and then alternately switches the rotational direction indication signal sent to the energization pattern determining means 30C between a signal indicating a second direction and a signal indicating the first direction each time the rotational direction switch 26 is pushed.

The energization pattern determining means 30C determines, as an energization pattern, the combination pattern of the phases of the armature coils to be energized to rotate the rotor in the indicated direction based on the information on the rotor position detected by the rotor position sensor 34 and the rotational direction indication signal sent from the rotational direction indicating means 30B and sends a driving signal to the motor driving section 30E in accordance with the determined energization pattern.

The motor driving section 30E has an inverter circuit comprised of switch elements, such as transistors and MOSFETs, bridge-connected to each other and feedback diodes each of which is connected in anti-parallel to each of the switch elements. The motor driving section 30E turns on a switch element to which the driving signal is sent from the energization pattern determining means 30C, thereby supplying the driving current to the armature coil for a predetermined phase of the motor generator 7 from a battery (not shown) in accordance with the energization pattern determined by the energization pattern determining means 30C.

In the motor driving section 30E, the feedback diodes form a rectifier circuit that rectifies an alternating-current voltage induced by the armature coils of the motor generator 7. When the motor generator operates as a generator, the alternating-current voltage induced by the armature coils of the motor generator 7 is rectified by the rectifier circuit and applied to the battery. In this case, the voltage applied by the armature coils to the battery through the rectifier circuit in the motor driving section can be controlled by turning on and off the switch elements forming the inverter circuit. The construction of the motor driving section described above and the method of controlling the voltage applied to the battery when the motor generator 7 operates as a generator are known.

The rotational speed arithmetically operating means 30D arithmetically operates the rotational speed of the rotor from the variation of the output signal of the rotor position sensor 34 with the rotation of the rotor and sends the arithmetical operation result to the rotational speed controlling section 30G.

The rotational speed indicating means 30F generates a rotational speed indication value that indicates the rotational speed of the motor generator 7 controlled to operate as a motor and sends the rotational speed indication value to the rotational speed controlling section 30G.

The controller 30 further has assist condition determining means 30H that determines a control condition (assist condition) when the assist mode is selected, and the rotational speed indicating means 30F is informed of the assist condition determined by the assist condition determining means 30H.

The assist condition determining means 30H determines whether an assist condition, which is a condition to permit the assisted operation, is met or not based on the state of the brake switch 32, the state of the clutch switch 33, the gear position detected by the gear position sensor 13, and the determination result of the falling determining means 30I (detection result of the falling detecting means) and sends the determination result to the rotational speed indicating means 30G.

In this embodiment, the assist condition (condition to permit the assisted operation) is determined to be met when the mode selection switch 25 is set in the ASSIST position, and the following conditions (A) to (D) are all met. If even one of these conditions is not met, the assist condition is not determined to be met.

(A) An operation to turn off the main clutch is performed (the clutch lever 23 is grasped).

(B) The brake is not operated (the brake lever 21 is not grasped).

(C) The transmission is set in the first speed position.

(D) The falling determining means 30I does not detects a falling.

The assist condition determining means 30H permits the rotational speed indicating means 30G to send the rotational speed indication value indicating the rotational speed other than 0 to the rotational speed controlling section 30G when the assist condition determining means 30H determines that the condition to permit the assisted operation is met, and sets the indication value of the rotational speed sent from the rotational speed indicating means 30G to the rotation controlling section 30G at 0 to prohibit the motor generator 7 from operating as a motor when the assist condition determining means 30H determines that the condition to permit the assisted operation is not met.

When the mode determining means 30A determines that the control mode is the engine start mode, the rotational speed indicating means 30F informs the rotational speed controlling section 30G of a preset starting rotational speed. At this time, the energization pattern determining means 30C determines an energization pattern to make the motor rotate in the engine start direction and sends a driving signal to a switch element of the inverter circuit of the motor driving section 30E in accordance with the determined energization pattern, thereby performing an engine starting motor control to make the motor generator 7 rotate in the engine start direction.

As described above, the rotational speed controlling section 30G performs PWM control of the driving current supplied to the motor generator 7 so as to maintain the rotational speed of the motor generator 7 at the preset rotational speed.

When start of the engine is completed, and it is detected that the rotational speed of the engine arithmetically operated by the rotational speed arithmetically operating means 30D reaches a start completion speed, the rotational speed controlling section 30G stops supply of the driving current from the motor driving section 30E to the motor generator 7, thereby stopping driving of the motor generator 7 as a motor. After that, the motor generator 7 is driven by the engine 5, so that the motor generator 7 operates as a generator to generate an electric power used for charging the battery. The electric power output from the motor generator 7 is converted into a direct-current power by a battery charging circuit (not shown) before being supplied to the battery.

When the mode determining means 30A determines that the assist mode is selected, and the assist condition determining means 30H determines that the condition to permit the assisted operation is met, the rotational speed indicating means 30F sends an indication value of the rotational speed, which provides a rotational speed characteristic of the motor during the assisted operation, to the rotational speed controlling section 30G to make the rotational speed controlling section 30G perform the assisting motor control.

In the assisting motor control, the motor driving section 30E supplies the driving current to the motor generator 7 in accordance with the energization pattern determined by the energization pattern determining means 30C based on the rotor position detection signal from the rotor position sensor 34 and the rotational direction indicated by the rotational direction switching means 30B, and makes the motor generator rotate in the indicated rotational direction (in the direction to move the vehicle backward or forward). At this time, the rotational speed controlling section 30G controls the rotational speed characteristics of the motor generator 7 to be suitable for the assisted operation by performing PWM control of the driving current supplied by the motor driving section 30E to the motor generator 7 in such a manner that the deviation between the rotational speed indicated by the rotational speed indicating means 30F and the rotational speed arithmetically operated by the rotational speed arithmetically operating means 30D (actual rotational speed of the motor generator) equals to 0.

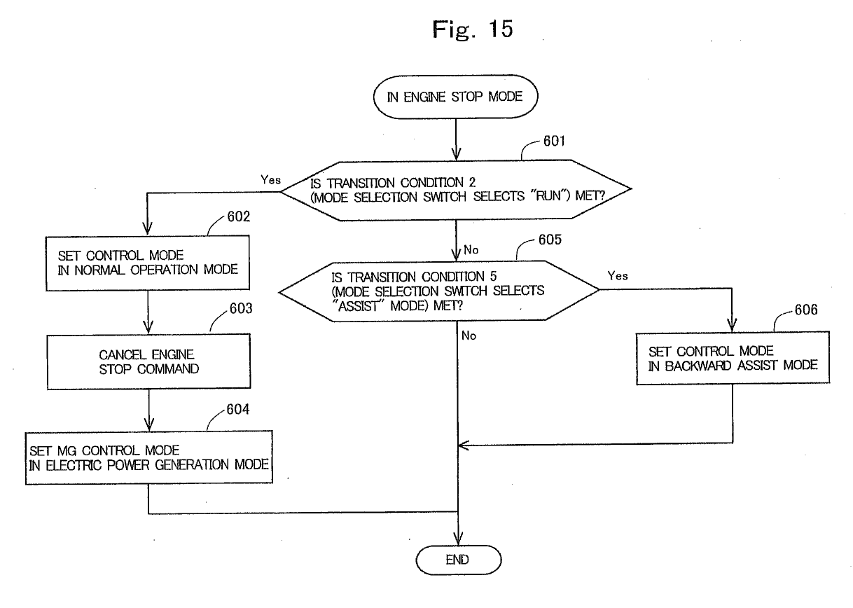

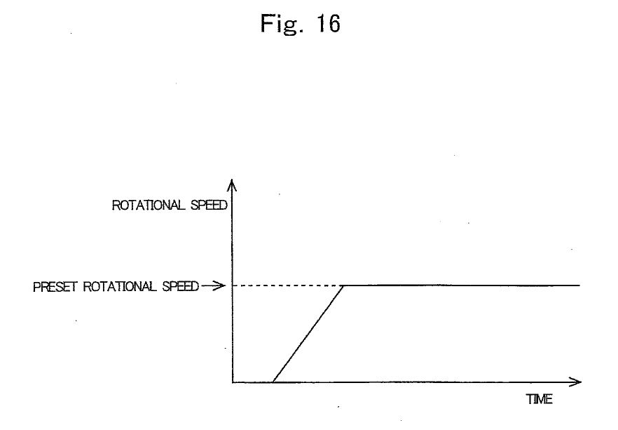

For example, the rotational speed characteristics of the motor during the assisted operation is as shown in FIG. 16, in which the rotational speed gradually increases with time to converge to a preset rotational speed. The rotational speed indicating means 30F changes the indication value of the rotational speed sent to the rotational speed controlling section 30G in the same way as the rotational speed characteristics shown in FIG. 15. The preset rotational speed shown in FIG. 16 is set in such a manner that the upper limit of the running speed during the assisted operation with the transmission set in the first speed position is a sufficiently low speed, such as the human walking speed, or preferably falls within a range of 2 to 3 km/h.

In this embodiment, the rotational direction indicating means 30B, the energization pattern determining means 30C, the rotational speed arithmetically operating means 30D, the motor driving section 30E, the rotational speed indicating means 30F and the rotational speed controlling section 30G form motor generator controlling means that performs the engine starting motor control to control the motor generator 7 to operate as a motor when the engine start command is issued when the normal operation mode is selected, and performs the assisting motor control to control the motor generator to operate as a motor when the assist mode is selected.

The controller 30 further comprises sub-clutch controlling means 30J that controls the sub-clutch 11 in such a manner that the sub-clutch 11 is turned on when the normal operation mode is selected and the sub-clutch 11 is turned off when the assist mode is selected, and engine stop command generating means 30K that sends an engine stop command to the engine controlling section 31 that controls the engine 5 when the engine stop mode or the assist mode is selected.

The engine controlling section 31 is a controlling section that controls the ignition timing of the engine 5 and the amount of fuel supplied to the engine 5. The engine controlling section 31 stops the engine 5 by stopping the engine ignition operation or stopping the fuel supply to the engine when the engine stop command is sent from the engine stop command generating section 30K.

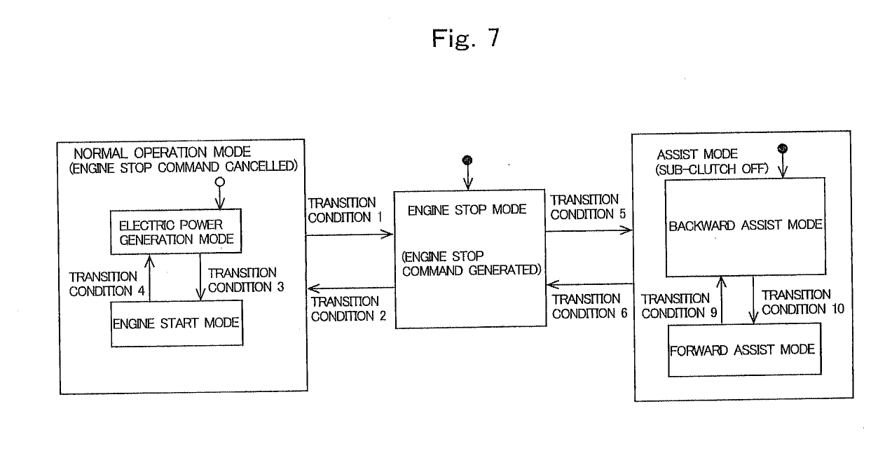

FIG. 7 is a block diagram for illustrating transition conditions for transition of the control mode of the controller 30 according to this embodiment. According to this embodiment, in the assist mode, an assisted operation to move the vehicle backward and an assisted operation to move the vehicle forward are performed. However, a predetermined transition condition has to be met in order to switch between the assisted operation in the backward direction and the assisted operation in the forward direction, and therefore, the assisted mode is divided into a backward assist mode and a forward assist mode. In FIG. 7, a combination of a black circle and a downward arrow indicates a default transition, and it is assumed that the control mode at the time of activation of the system is the engine stop mode.

Transition conditions 1 to 6 and 6, 9 and 10 shown in FIG. 7 are as follows.

Transition condition 1: The mode selection switch 25 is in the OFF position or the ASSIST position.

Transition condition 2: The mode selection switch 25 is switched to the RUN position.

Transition condition 3: The engine starter switch is in the ON position, the engine is in the stopped state, and the transmission is in a neutral position, and an operation of turning off the main clutch (an operation of grasping the clutch lever) is being performed.

Transition condition 4: The engine starter switch is in the OFF position, start of the engine is completed, or the transmission is in a position other than the neutral position, and the main clutch is in the on state.

Transition condition 5: The control mode is the engine stop mode, and then the mode selection switch is switched from the OFF position to the ASSIST position.

Transition condition 6: The mode selection switch is switched to the OFF position or the RUN position.

Transition condition 9: The rotational direction switch 26 is pushed once in the backward assist mode.

Transition condition 10: The rotational direction switch 26 is pushed in the forward assist mode.

In this embodiment, when the condition that the mode selection switch 25 is in the OFF position or the ASSIST position (transition condition 1) is met, the control mode transitions from the normal operation mode to the engine stop mode. When the mode selection switch 25 is switched to the RUN position (when the transition condition 2 is met), the control mode transitions from the engine stop mode to the normal operation mode.

In the normal operation mode, the control mode is first an electric power generation mode. In this state, when the condition is met that the engine starter switch is in the ON position, the engine is in the stopped state, and the transmission is in the neutral position and the operation of turning off the main clutch (operation of grasping the clutch lever) is being performed (when the transition condition 3 is met), the control mode transitions to the engine start mode. In addition, when the condition that the engine starter switch is in the OFF position is met, or when the condition is met that start of the engine is completed, or the transmission is in a position other than the neutral position and the main clutch is in the on state (that is, engaged) (when the transition condition 4 is met), the control mode transitions from the engine start mode to the electric power generation mode. In the electric power generation mode, the alternating-current voltage output from the motor generator 7 is rectified by the rectifier circuit in the motor driving section 30E and then supplied to the battery, and the switch elements of the inverter circuit in the motor driving section 30E are controlled to maintain the voltage applied to the battery in a preset range.

Furthermore, when the control mode is the engine stop mode, and the mode selection switch is switched from the OFF position to the ASSIST position (when the transition condition 5 is met), the control mode transitions from the engine stop mode to the assist mode, and when the mode selection switch is switched to the OFF position or the RUN position (when the transition condition 6 is met), the control mode transitions from the assist mode to the engine stop mode.

When the control mode transitions to the assist mode, the control mode first transitions to the backward assist mode. At this time, the sub-clutch 11 is turned off.

If the rotational direction switch 26 is pushed once in the backward assist mode (the transition condition 9 is met), the control mode transitions to the forward assist mode. If the rotational direction switch 26 is pushed in this forward assist mode (the transition condition 10 is met), the control mode transitions to the backward assist mode. In this way, when in the assist mode, the control mode is alternately switched between the backward assist mode and the forward assist mode each time the rotational direction switch 26 is pushed. Since the control mode first transitions to the backward assist mode when the assist mode is selected, there is no possibility that the driver drives the vehicle in the wrong direction in the assist mode.

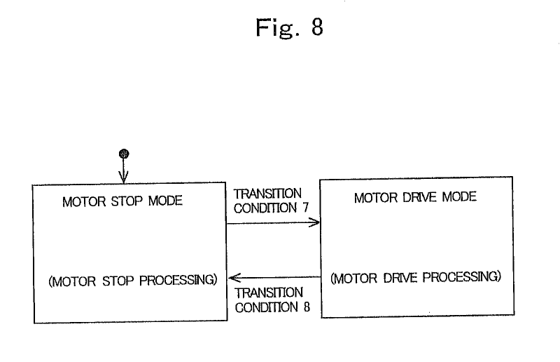

As shown in FIG. 8, in the backward assist mode and the forward assist mode, a motor stop mode to stop the motor or a motor drive mode to make the motor generator 7 operate as a motor is performed depending on the manipulation by the driver. Transition conditions 7 and 8 shown in FIG. 7 are as follows.

Transition condition 7: In the motor stop mode, an operation to turn off the main clutch is being performed, the brake is not operated, the transmission is set in the first speed position, and the falling determining means 30I determines that the vehicle has not fallen.

Transition condition 8: In the motor drive mode, it is determined that the brake is being operated, it is detected that the transmission is set in a position other than the first speed position, or the falling determining means determines that the vehicle has fallen.

In the motor stop mode, supply of the driving current to the motor generator 7 is stopped to keep the motor in the stopped state. In the motor drive mode, a process to drive the motor generator so as to rotate the driving wheel in the backward direction or the forward direction is performed.

In the motor stop mode, when an operation to turn off the main clutch is being performed, the brake is not operated, the transmission is set in the first speed position, and the falling determining means 30I determines that the vehicle has not fallen (when the transition condition 7 is met), the control mode transitions to the motor drive mode, and a process to make the motor generator 7 operate as a motor according to the rotational speed characteristics shown in FIG. 16 is performed. More specifically, after the mode selection switch 25 is switched to the ASSIST position to switch the control mode to the assist mode, the main clutch is disengaged, and the transmission is set in the first speed position. Then, the assisting motor control to make the motor generator 7 operate as a motor for the assisted running is started. Since the transmission is always set in the first speed position during the assisted running, the upper limit value of the rotational speed of the motor generator that provides the upper limit of the speed of the vehicle during the assisted running is determined.

Since the transition to the motor drive mode occurs on the assumption that the operation to turn off the main clutch is being performed, the rotation of the motor generator 7 is not transmitted to the driving wheel and thus the assisted running does not start, even if the control mode transitions to the motor drive mode, and the control to make the motor generator 7 operate as a motor is started. After the control to make the motor generator 7 operate as a motor is started, the main clutch is gradually brought into engagement. And when the main clutch is brought into a half-clutch position, the rotation of the motor generator 7 is transmitted to the driving wheel, and the assisted running starts. Even if the driver accidentally skips the half-clutch position and suddenly turns on the main clutch, sudden acceleration of the vehicle is prevented, and thus the safety is ensured because the rotational speed of the motor generator 7 in the assist mode does not increase beyond the preset rotational speed, which produces a vehicle speed of 2 to 3 km/h.

In the motor drive mode, when it is determined that the brake is being operated, it is detected that the transmission is set in a position other than the first speed position, or the falling determining means determines that the vehicle has fallen (when the transition condition 8 is met), the control mode transitions to the motor stop mode. That is, when the brake is operated, it is determined that the driver has indicated an intention to stop the vehicle, and the motor generator 7 is stopped driving.

In the embodiment described above, since the sub-clutch 11 is turned on when a mode other than the assist mode is selected, power can be transmitted between the motor generator 7 and the engine 5. In this state, the engine can be started by controlling the motor generator 7 to operate as a motor. Once the engine 5 has started, the engine drives the motor generator 7 to operator as a generator to generate an electric power used for battery charging or other purposes.

When the assist mode is selected, the assisting motor control is performed to make the motor generator 7 operate as a motor in a state where the sub-clutch 11 is turned off to disconnect the power transmission from the engine 5 to the driving wheel 3, and therefore, the rotation of the motor generator 7 can be transmitted to the driving wheel 3 independently of the rotation of the engine 5. Therefore, the motor generator 7 can be used as a power source to move the vehicle forward or backward, and even a heavy vehicle can be easily turned or put into a garage.

In addition, in the embodiment described above, when the assisted operation is performed, as shown in FIG. 16, the rotational speed is controlled to gradually increase to the preset rotational speed. Therefore, an accident dangerous for the driver, such as falling, can be prevented by setting an appropriate preset rotational speed.

In addition, in the embodiment described above, when a mode other than the normal operation mode is selected, the engine stop command generating means 30K generates an engine stop command. Therefore, when the motor generator 7 is used as a power source for the assisted running, the engine can be kept in the stopped state. As a result, the vehicle can be prevented from being driven by the engine and starting despite the intention of the driver when the sub-clutch 11 is turned on by an erroneous operation during the assisted running, and thus, the safety is improved.

In addition, in the embodiment described above, turn on and off of the sub-clutch 11 occurs only when the engine is stopped, so that it is not necessary to consider a situation where the sub-clutch 11 is used in a half-clutch position. Therefore, the sub-clutch 11 can be an inexpensive clutch that has a simple structure including no synchronization mechanism, and the cost increase due to the addition of the sub-clutch can be minimized.

In the embodiment described above, the motor generator controlling means is comprised so that the rotational speed of the motor generator gradually increases to the preset rotational speed during the assisting motor control. Since the assisting motor driving means is comprised in this way, the assisted running can be achieved at a safe speed without sudden acceleration by setting the preset rotational speed at an appropriate value, and thus, an accident, such as falling, can be prevented from occurring when the vehicle is moved backward.

In the embodiment described above, the preset rotational speed of the motor generator 7 during the assisted operation is set so that the upper limit of the vehicle speed falls within a range of 2 to 3 km/h. Therefore, the upper limit of the running speed during the assisted operation can be set at a low speed close to the human walking speed, and thus, the safety is improved.

In the embodiment described above, as shown in FIG. 8, the motor generator controlling means is comprised so that the assisting motor control starts on the condition that the driver is performing an operation to turn off the main clutch 603 (transition condition 7). Therefore, when the clutch lever 23 is not grasped, driving by the motor generator 7 does not start even if the assist mode is selected. And driving by the motor generator 7 starts only when the assist mode is selected and the clutch lever 23 is grasped. Therefore, the motor generator 7 can be prevented from suddenly starting operating as a motor and starting the assisted running when the mode selection switch 25 selects the assist mode. According to this construction, the assisted running starts only after the mode selection switch selects the assist mode, and then the driver releases the clutch lever 23 (turns on the main clutch) with the intention to start the assisted running. Therefore, the assisted running can be prevented from starting despite the intention of the driver, and thus the safety is improved.

In the embodiment described above, the motor generator controlling means is comprised so that the assisting motor control starts only when the transmission 601 of the power transmission device 6 is set in the first speed gear position. According to this construction, the assisted running always occurs in the first speed gear position, so that a high torque can be transmitted from the motor generator to the driving wheel during the assisted running to facilitate the assisted running. In addition, since the gear position during the assisted running is fixed at the first speed position, the preset rotational speed of the motor generator can be easily set.

In the embodiment described above, the inclination angle sensor 35 comprised of an acceleration sensor or the like and the falling determining means 30I form the falling detecting means that detects that the motorcycle has fallen, and the assisting motor driving means is comprised so as to stop the assisting motor control when the falling detecting means detects that the vehicles has fallen. According to this construction, the motor generator 7 can be prevented from rotating the driving wheel 3 when the vehicle has fallen, and thus, the safety is improved.

In the embodiment described above, the mode selection switch 25 has the first to third positions and is comprised so as to switch from the first position to the third position via the second position and from the third position to the first position via the second position and assume the first position to select the normal operation mode, assume the second position to select the engine stop mode, and assume the third position to select the assist mode.

According to this construction, since the engine stop mode is surely selected in the course of switching from the state where the mode selection switch selects the normal operation mode to the state where the mode selection switch selects the assist mode, the engine can be surely stopped when the assist mode is selected.

According to the construction described above, since the engine can be stopped when the assisted running is performed, sudden acceleration of the vehicle because of accidental turn on of the sub-clutch by an erroneous operation during the assisted running can be prevented, and thus the safety is improved.

In the embodiment described above, there is provided the rotational direction indicating means 30B that generates a rotational direction indication signal that instructs the motor generator 7 to rotate in the rotational direction to start the engine when the engine starting motor control is performed and generates a rotational direction indication signal that instructs the motor generator to rotate in the rotational direction corresponding to the direction of travel of the motorcycle when the assisting motor control is performed, and the motor generator controlling means is comprised so as to rotate the motor generator in the rotational direction indicated by the rotational direction indication signal generated by the rotational direction indicating means 30B when the starting motor control or the assisting motor control is performed. According to this construction, by switching the rotational direction indicated by the rotational direction indication signal, the direction of running of the vehicle during the assisted operation can be appropriately switched, and the motor generator 7 can be used as a power source to achieve the assisted running in the backward direction and the assisted running in the forward direction.

In the embodiment described above, the rotational direction switch 26 comprised of a push button switch is provided. The rotational direction switch 26 is a switch that is manipulated to switch the rotational direction of the motor generator during the assisting motor control between the first rotational direction to move the motorcycle backward and the second direction to move the motorcycle forward. The rotational direction indicating means 30 is comprised to assume the rotational direction first indicated when the assist mode is selected as the first rotational direction and alternately switch the rotational direction between the different directions each time a push button of the rotational direction switch 26 is pushed. According to this construction, each time the push button of the rotational direction switch 26 is pushed, the rotational direction of the motor generator can be switched to alternately switch the direction of the assisted running between the forward direction and the backward direction, so that the operation of switching the running direction is simplified. In addition, during the assisted operation, the vehicle can be moved forward without starting the engine, and therefore, the assisted operation can be facilitated.

In the embodiment described above, when the assist mode is selected, the assisted running in both the forward and backward directions is allowed. However, the motor generator controlling means may be comprised so as to rotate the motor generator only in the direction to move the vehicle backward when the assisting motor controlling operation is performed.

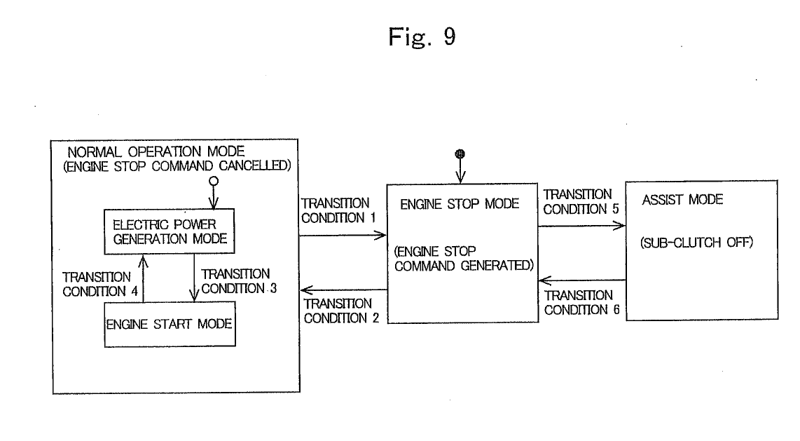

FIG. 9 is a block diagram for illustrating transitions of the control mode in the case where the motor generator controlling means is comprised so as to rotate the motor generator only in the direction to move the vehicle backward when the assisting motor control is performed. The block diagram of FIG. 9 is the same as the block diagram of FIG. 7 except that, in the assist mode, the assisting motor control is performed in such a manner that only the assisted running in the backward direction is performed.

In order to turn the motorcycle, both the forward movement and the backward movement of the motorcycle are preferably allowed in the assisted operation. However, the motorcycle can also be moved forward by using the engine, and therefore, even if only the backward movement is allowed in the assisted operation as in this embodiment, the object of enabling movement of a heavy vehicle can be attained.

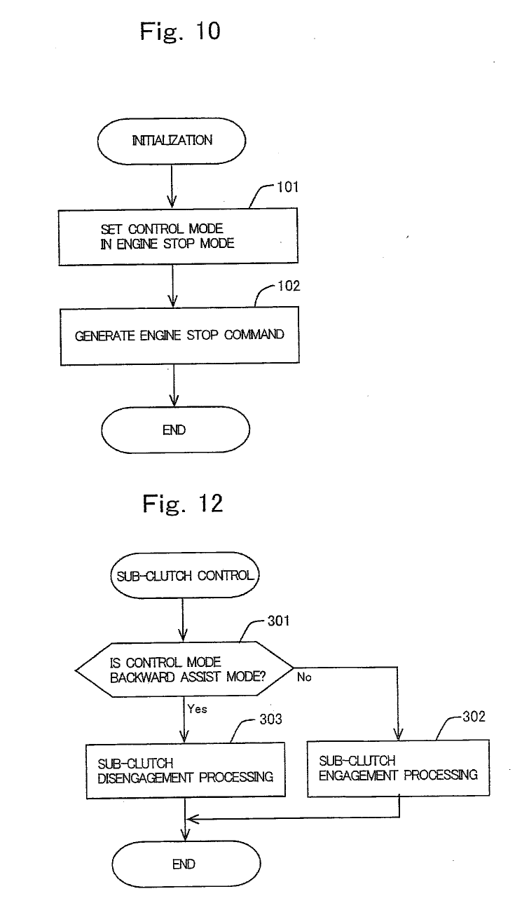

The controller 30 shown in FIG. 6 can be implemented by a computer in the ECU executing a predetermined program. FIGS. 10 to 15 are flowcharts illustrating algorithms of various processing performed by the computer to implement the controller 30.

FIG. 10 shows an initialization processing performed when the system is activated. In this processing, the control mode is set in the engine stop mode as an initial setting in step 101, and the engine stop command is generated in step 102.

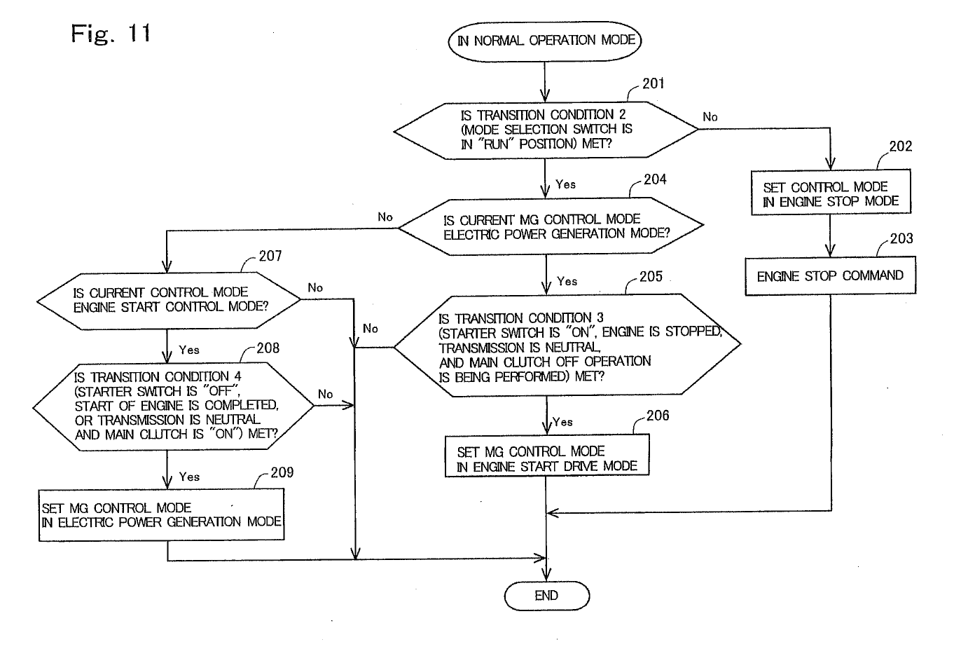

FIG. 11 shows an algorithm of a processing performed when the normal operation mode is selected. In this processing, it is first determined in step 201 whether the transition condition 2 is met or not (whether the mode selection switch is set in the RUN position or not). If the transition condition is not met, the process proceeds to step 202 where the control mode is set in the engine stop mode. Then, in step 203, the engine stop command is generated, and the processing is ended.

If it is determined in step 201 that the transition condition 2 is met, the process proceeds to step 204 where it is determined whether the current control mode of the motor generator (MG) is the electric power generation mode or not. If the control mode is the electric power generation mode, the process proceeds to step 205 where it is determined whether the transition condition 3 (whether the starter switch is in the ON position, the engine is in the stopped state, the transmission is in the neutral position, and the operation of turning off the main clutch is being performed) is met or not. If the transition condition 3 is not met, the processing is ended. If the transition condition 3 is met, the process proceeds to step 206 where the control mode of the motor generator is set in the engine start mode, and then, the processing is ended.

If it is determined in step 204 that the current control mode is not the electric power generation mode, the process proceeds to step 207 where it is determined whether the current control mode is the engine start mode or not. If the current control mode is not the engine start mode, the processing is ended. If the current control mode is the engine start mode, it is determined in step 208 whether the transition condition 4 (the starter switch is in the OFF position, start of the engine is completed, or the transmission is in a position other than the neutral position, and the main clutch is in the on state) is met or not. If the transition condition 4 is not met, the processing is ended. If the transition condition 4 is met, the control mode is set in the electric power generation mode in step 209, and then, the processing is ended.

FIG. 12 shows a processing performed to implement the sub-clutch controlling means. In this processing, it is determined in step 30I whether the control mode is the backward assist mode or not. If the control mode is not the backward assist mode, the process proceeds to step 302 where a sub-clutch engagement processing is performed, and then, the processing is ended. If it is determined in step 30I that the control mode is the backward assist mode, a sub-clutch disengagement processing is performed in step 303, and then, the processing is ended.

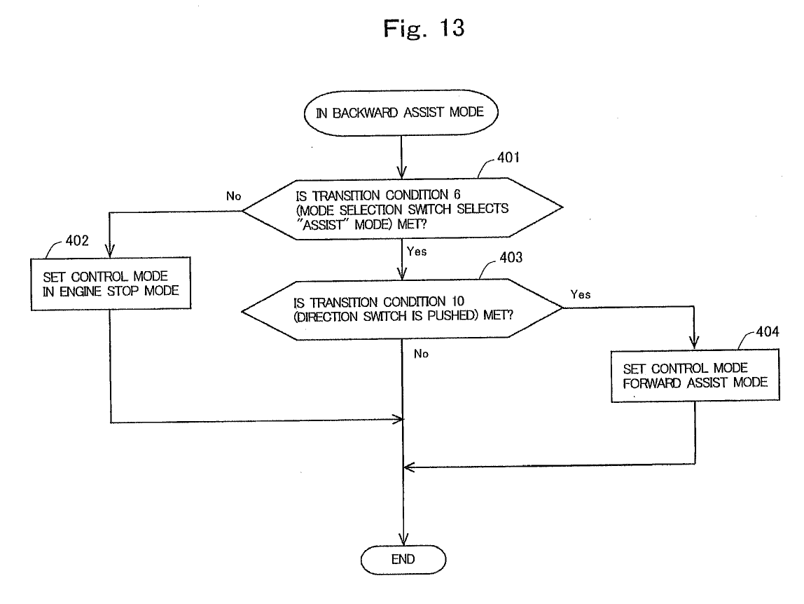

FIG. 13 shows a processing performed when the backward assist mode is selected in the case where both the backward assist mode and the forward assist mode are allowed in the assist mode as shown in FIG. 6. In this processing, first, it is determined in step 401 whether the transition condition 6 (the mode selection switch is in the assist position) is met or not. If it is determined that the transition condition 6 is not met (the mode selection switch does not select the assist mode), the control mode is set in the engine stop mode in step 402, and then, the processing is ended. If it is determined in step 401 that the transition condition 6 is met, the process proceeds to step 403 where it is determined whether the transition condition 10 (the rotational direction switch is pushed) is met or not. If the transition condition 10 is not met, the processing is ended. If the transition condition 10 is met, the control mode is set in the forward assist mode in step 404, and then, the processing is ended.

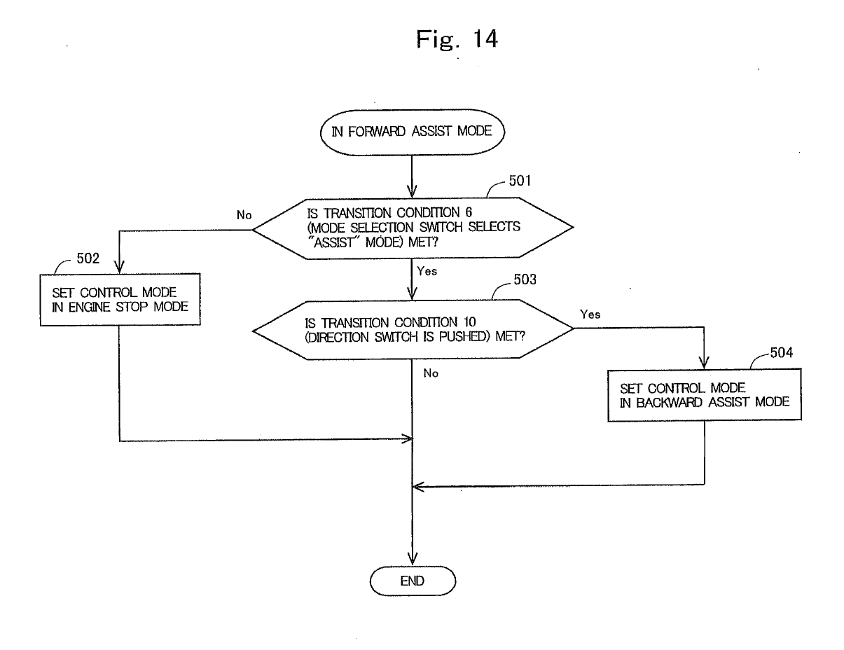

FIG. 14 shows a processing performed when the forward assist mode is selected. In this processing, first, it is determined in step 501 whether the transition condition 6 (the mode selection switch is in the assist position) is met or not. If the transition condition 6 is not met, the control mode is set in the engine stop mode in step 502, and the processing is ended. If it is determined in step 501 that the transition condition 6 is met, it is determined in step 503 whether the transition condition 10 (the rotational direction switch is pushed) is met or not. If it is determined that the transition condition 10 is not met, the processing is ended. If it is determined that the transition condition 10 is met, the control mode is set in the backward assist mode in step 504, and the processing is ended.

FIG. 15 shows a processing performed when the engine stop mode is selected. In this processing, it is determined in step 601 whether the transition condition 2 (the mode selection switch is in the RUN position) is met or not. If it is determined that the transition condition 2 is met (the mode selection switch is in the RUN position), the process proceeds to step 602 where the control mode is set to be the normal operation mode, and then, the engine stop command is cancelled in step 603, the control mode is set in the electric power generation mode in step 604, and the processing is ended. If it is determined in step 601 that the transition condition 2 is not met, the processing proceeds to step 605 where it is determined whether the transition condition 5 (the mode selection switch is switched from the OFF position to the ASSIST position) is met or not. If the transition condition 5 is not met, the processing is ended without doing anything. If the transition condition 5 is met, the control mode is set in the backward assist mode in step 606, and then, the processing is ended.

In the embodiment described above, the motor generator controlling means is comprised so as to gradually increase the rotational speed of the motor generator 7 to the preset rotational speed when the assist mode is selected, and the motor drive determination condition is met. However, the present invention is not limited to the construction of the motor generator controlling means. For example, a throttle sensor that detects the amount of manipulation of the throttle, which is manipulated to adjust the rotational speed of the engine, may be provided, and the motor generator controlling means may be comprised so as to change the rotational speed of the motor generator according to the amount of manipulation of the throttle detected by the throttle sensor within a range that does not exceed the preset rotational speed in the assisting motor control. The amount of manipulation of the throttle can be detected by detecting the amount of manipulation of the accelerator grip 20, for example.

According to this construction, the vehicle speed in the assisted operation is proportional to the amount of manipulation of the throttle, so that the driver can adjust the vehicle speed in the assisted running.

In the embodiment described above, when the assisting motor control is performed, the rotational speed arithmetically operating means 30D detects the rotational speed of the motor generator 7, and the motor generator 7 is controlled to keep the detected rotational speed at the indicated rotational speed. Alternatively, however, a vehicle speed sensor that detects the vehicle speed may be provided, and the motor generator controlling means may be comprised so as to gradually increase the vehicle speed detected by the vehicle speed sensor to a limit speed when the assisting motor control is performed.

In the embodiment described above, the assisted running is performed on the condition that the transmission is in the first speed gear position. However, in the case where the gear position sensor 13 that detects the gear position of the transmission in the power transmission device is provided, the motor generator controlling means may be comprised so as to change the preset rotational speed according to the gear position detected by the gear position sensor 13.

In order to ensure the safety of the assisted running, alarm means that produces an alarm sound when the motor generator controlling means is performing the assisting motor control is preferably provided.

In the embodiment described above, the engine starter switch doubles as the rotational direction switch, and the kill switch doubles as the mode selection switch. However, a rotational direction switch separate from the engine starter switch or a mode selection switch separate from the kill switch may be provided.

In the embodiment described above, the motor generator controlling means is comprises so as to perform the engine starting motor control to control the motor generator to operate as an engine starter motor when the engine start command is received when the normal operation mode is selected and the assisting motor control to control the motor generator to operate as a motor when the assist mode is selected. However, the present invention is not limited to the construction of the motor generator controlling means according to the embodiment described above. For example, the engine controlling section may perform the engine starting motor control. Therefore, the motor generator controlling means can be comprised so as to perform at least the assisting motor control to make the motor generator operate as a motor when the assist mode is selected.

As described above, according to the present invention, the sub-clutch is provided between the crankshaft of the engine and the power transmission device, and the engine can be disconnected from the power transmission device by turning off the sub-clutch. Therefore, the motor generator can be driven as a motor, and the rotation of the motor generator can be transmitted to the driving wheel without influence of the rotation of the engine, and thus, the motor generator can be used as a power source to move the vehicle backward or both backward and forward.

In addition, according to the present invention, simply adding the sub-clutch between the crankshaft of the engine and the power transmission device enables power transmission from the motor generator to the driving wheel, and there is no need to provide the conventional power transmission mechanism having a one-way clutch between the motor and the engine and a one-way clutch between the motor and the driving wheel, so that the construction of the power transmission device can be prevented from being complicated.

According to the present invention, since the motor generator that doubles as a motor and a generator is used as a dynamo electric machine, the engine can have a simple construction and a small size compared with the conventional motorcycle having an engine incorporating an engine starter motor and a generator.

In addition, according to the present invention, since the engine stop command is generated when the assist mode is selected, the engine can be kept stopped when the assisted running is performed using the motor generator as a power source. Therefore, sudden acceleration of the vehicle because of accidental turn on of the sub-clutch by an erroneous operation during the assisted running can be prevented, and thus the safety is improved.

The present invention disclosed in this specification and the drawings will be summarized in the following. This specification and the drawings disclose at least the following first to twenty-first aspects of the present invention.

(1) First Aspect

A first aspect of the present invention disclosed by the present application is a motorcycle comprising: an engine; an engine controlling section that controls said engine; and a power transmission device that has a main clutch turned on and off during running and transmits a rotation of said engine to a driving wheel when the main clutch is in an on state, said engine controlling section being configured to stop said engine when an engine stop command is provided thereto.

The motorcycle according to the first aspect of the present invention further comprises: a sub-clutch that is inserted between an output shaft of said engine and said power transmission device and is capable of being controlled to be on and off; a motor generator that is comprised of a dynamo electric machine functioning as a motor and a generator and has a rotating shaft coupled to said power transmission device in such a manner that the rotating shaft is coupled to the output shaft of said engine via said sub-clutch and coupled to said driving wheel via said main clutch; a mode selection switch that selects a normal operation mode that allows a normal operation using said engine as a power source, an engine stop mode, or an assist mode that allows an assisted operation using said motor generator as a power source; and a processor that generates and cancels said engine stop command and controls said sub-clutch and said motor generator according to the mode selected by said mode selection switch. Said processor is configured to: (a) generate said engine stop command when said engine stop mode or said assist mode is selected and control generation and cancellation of said engine stop command so as to cancel said engine stop command when said normal operation mode is selected; (b) control said sub-clutch in such a manner that said sub-clutch is turned on when a mode other than said assist mode is selected and turned off when said assist mode is selected; and (c) perform an assisting motor control to control said motor generator to operate as a motor when said assist mode is selected.

According to the construction described above, when a mode other than the assist mode is selected, the sub-clutch is turned on, so that power can be transmitted between the motor generator and the engine. In this state, the engine can be started by controlling the motor generator to operate as a motor, and once the engine is started, the engine can drive the motor generator to operate as a generator to generate an electric power used for battery charging or other purposes.

When the assist mode is selected, the sub-clutch is turned off to disconnect the power transmission from the engine to the driving wheel, and then, the assisting motor control is performed to make the motor generator operate as a motor. Therefore, the rotation of the motor generator can be transmitted to the driving wheel independently of the rotation of the engine. Therefore, the motor generator can be used as a power source to move the vehicle forward and (or) backward, and even a heavy vehicle can be easily turned or put into a garage, for example.

In this specification, operation and running of the motorcycle using the motor generator as a power source are referred to as “assisted operation” and “assisted running”, respectively.

According to this aspect, since the power source other than the engine is used for the assisted running, the assisted running can be performed by a manipulation different from the manipulation to perform the normal operation. Therefore, the driver can consciously perform the assisted operation, and the vehicle can be prevented from suddenly moving backward despite the intention of the driver because of an erroneous operation. In general, the dynamo electric machine can be easily controlled to gradually increase the rotational speed to a preset speed, and this holds true for the motor generator. Therefore, by using the motor generator as a power source for the assisted running, the running speed during the assisted running can be easily set in a safe range (2 to 3 km/h, for example), and thus the safety is improved.

In addition, according to this aspect, simply adding the sub-clutch between the crankshaft of the engine and the power transmission device enables power transmission from the motor generator to the driving wheel, and there is no need to provide the conventional power transmission mechanism having a one-way clutch between the motor and the engine and a one-way clutch between the motor and the driving wheel, so that the construction of the power transmission device can be prevented from being complicated. In addition, since the motor generator that doubles as a motor and a generator is used as the dynamo electric machine, the engine can have a simple construction and a small size compared with the conventional motorcycle having an engine incorporating two dynamo electric machines, that is, a motor used for engine start and a generator used for battery charging.

According to this aspect, since the engine stop command is generated when a mode other than the normal operation mode is selected, the engine can be kept stopped when the assisted running is performed using the motor generator as a power source. Therefore, it is possible to prevent the vehicle from suddenly being driven by the engine to start running despite the intention of the driver when the sub-clutch is accidentally turned on because of an erroneous operation during the assisted running, and thus the safety is improved.

According to the construction described above, turn on and off of the sub-clutch occurs only when the engine is stopped, so that it is not necessary to consider a situation where the sub-clutch is used in a half-clutch position. Therefore, the sub-clutch can be a clutch that has a simple structure including no synchronization mechanism, and the cost increase due to the addition of the sub-clutch can be minimized.

(2) Second Aspect

A second aspect of the present invention is applied to the first aspect of the present invention. According to this aspect, said processor is configured to perform an engine starting motor control to control said motor generator to operate as a motor when an engine start command is provided thereto when said normal operation mode is selected.

(3) Third Aspect

A third aspect of the present invention is applied to the first or second aspect of the present invention. According to this aspect, said processor is configured to gradually increase a rotational speed of said motor generator to a preset rotational speed when said assisting motor control is performed.

If the motor generator controlling means is configured as described above, the assisted operation can be achieved at a safe speed without sudden acceleration by setting the preset rotational speed at an appropriate value, and therefore, an accident, such as falling, can be prevented from occurring when the vehicle is moved backward.

(4) Fourth Aspect

A fourth aspect of the present invention is applied to the first or second aspect of the present invention. According to this aspect, the motorcycle further comprises a throttle sensor that detects the amount of manipulation of a throttle manipulated to adjust a rotational speed of said engine, and said processor is configured to change a rotational speed of said motor generator according to the amount of manipulation of the throttle detected by said throttle sensor within a range that does not exceeds a preset rotational speed when said assisting motor control is performed.

According to this construction, the vehicle speed in the assisted operation is proportional to the amount of manipulation of the throttle, so that the driver can adjust the vehicle speed in the assisted running.

(5) Fifth Aspect

A fifth aspect of the present invention is applied to the third or fourth aspect of the present invention. According to this aspect, said preset rotational speed is set so that an upper limit of a vehicle speed falls within a range of 2 to 3 km/h.

According to this construction, the upper limit of the running speed during the assisted operation can be set at a low speed close to the human walking speed, and thus, the safety is improved.

(6) Sixth Aspect

A sixth aspect of the present invention is applied to the first or second aspect of the present invention. According to this aspect, the motorcycle further comprises a vehicle speed sensor that detects a vehicle speed, and said processor is configured to gradually increase the vehicle speed detected by said vehicle speed sensor to a preset limit speed when said assisting motor control is performed.

(7) Seventh Aspect

A seventh aspect of the present invention is applied to the sixth aspect of the present invention. According to this aspect, an upper limit of said vehicle speed is set to fall within a range of 2 to 3 km/h.

(8) Eighth Aspect

An eighth aspect of the present invention is applied to any one of the first to seventh aspects of the present invention. According to this aspect, said processor is configured to start said assisting motor control on the condition that a driver is performing an operation of turning off said main clutch.

The operation of turning off the main clutch performed by the driver can be detected by a sensor attached to a clutch lever. Typically, the engine of the motorcycle can be started only when the clutch lever is grasped, and the transmission is set in the neutral gear position. Therefore, a sensor that detects that the clutch lever is grasped is typically provided.

According to the construction described above, when the clutch lever is not grasped, driving of the motor generator is not started even if the assist mode is selected, and driving of the motor generator is started only when the assist mode is selected when the clutch lever is grasped. Therefore, the motor generator can be prevented from being suddenly driven to start the assisted running when the mode selection switch selects the assist mode. According to this aspect, the assisted running can be started only when the driver releases the clutch lever (turn on the main clutch) with the intention to start the assisted running after the mode selection switch selects the assist mode, and therefore, the assisted running can be prevented from being accidentally started despite the intention of the driver, and thus the safety is improved.

(9) Ninth Aspect

A ninth aspect of the present invention is applied to any one of the first to eighth aspects of the present invention. According to this aspect, in the motorcycle described in any of the first to eighth aspects, said processor is configured to perform said assisting motor control only when a transmission in said power transmission device is set in a first speed gear position.

According to this construction, since the assisted running always occurs in the first speed gear position, a high torque can be transmitted from the motor generator to the driving wheel during the assisted running to facilitate the assisted running. If the gear position in the assisted running may vary, the gear position has to be detected in order to determine the preset value of the rotational speed (preset rotational speed) of the motor generator during the assisted running, and the preset rotational speed has to be determined according to the detected gear position. However, according to the construction described above, since the gear position during the assisted running is fixed at the first speed gear position, the preset rotational speed of the motor generator can be easily set.

(10) Tenth Aspect

A tenth aspect of the present invention is applied to the third, fourth, or fifth aspect of the present invention. According to this aspect, the motorcycle further comprises a gear position sensor that detects a gear position of a transmission in said power transmission device. In this case, said processor is configured to switch the preset rotational speed according to the gear position detected by said gear position sensor.

(11) Eleventh Aspect

An eleventh aspect of the present invention is applied to any one of the first to tenth aspects of the present invention. According to this aspect, said processor is configured to stop operation of said motor generator as a motor when an operation of a brake by a driver is detected when said assisting motor control is performed.

(12) Twelfth Aspect

A twelfth aspect of the present invention is applied to any one of the first to eleventh aspects of the present invention. According to this aspect, the motorcycle further comprises alarm means that produces an alarm sound when said processor is performing said assisting motor control.

According to this construction, since the driver can be informed that the assist mode is selected, the assist operation can be prevented from occurring despite the intention of the driver when the assisted operation is accidentally selected by an erroneous operation of the mode selection switch. In addition, the driver can be alerted when the assisted operation is performed, and thus the safety is improved.

(13) Thirteenth Aspect

A thirteenth aspect of the present invention is applied to any one of the first to twelfth aspects of the present invention. According to this aspect, the motorcycle further comprises falling detecting means that detects whether the motorcycle is in a fallen state or not, and said processor is configured to stop said assisting motor control when said falling detecting means detects a falling.

According to this construction, the motor generator can be prevented from rotating the driving wheel when the vehicle has fallen, and thus the safety is improved.

(14) Fourteenth Aspect

A fourteenth aspect of the present invention is applied to any one of the first to thirteenth aspects of the present invention. According to this aspect, said processor is configured to rotate said motor generator only in a direction to move the motorcycle backward when said assisting motor control is performed.

In order to turn the motorcycle, both the forward movement and backward movement of the motorcycle are preferably allowed in the assisted operation. However, the motorcycle can also be moved forward by using the engine, and therefore, even if only the backward movement is allowed in the assisted operation, the object of enabling movement of a heavy vehicle can be attained.

(15) Fifteenth Aspect

A fifteenth aspect of the present invention is applied to any one of the first to fourteenth aspects of the present invention. According to this aspect, said mode selection switch has first to third positions and is configured to switch from the first position to the third position via a second position and from the third position to the first position via the second position and to assume said first position to select said normal operation mode, assume said second position to select the engine stop mode, and assume said third position to select the assist mode.

According to the construction described above, since the engine stop mode is surely selected in the course of switching from the state where the mode selection switch selects the normal operation mode to the state where the mode selection switch selects the assist mode, the engine can be surely stopped when the assist mode is selected.

According to the construction described above, since the engine can be stopped when the assisted running is performed, sudden acceleration of the vehicle because of accidental turn on of the sub-clutch by an erroneous operation during the assisted running can be prevented, and thus the safety is improved.

(16) Sixteenth Aspect

A sixteenth aspect of the present invention is applied to the second aspect of the present invention. According to this aspect, said processor is configured to control said motor generator so as to rotate said motor generator in a rotational direction at the time of start of the engine when said engine starting motor control is performed and to rotate said motor generator in a rotational direction corresponding to the direction of travel of the motorcycle when said assisting motor control is performed.

According to the construction described above, the direction of running during the assisted operation can be appropriately switched by switching the rotational direction indicated by the rotational direction indication signal.

(17) Seventeenth Aspect

A seventeenth aspect of the present invention is applied to the sixteenth aspect of the present invention. According to this aspect, the motorcycle further comprises a rotational direction switch that is comprised of a push button switch, a push button of the rotational direction switch being pushed to switch the rotational direction of the motor generator during said assisting motor control between a first rotational direction to move the motorcycle backward and a second rotational direction to move the motorcycle forward, and said processor is configured to alternately switch the indicated rotational direction between the different directions each time the push button of said rotational direction switch is pushed on the assumption that the rotational direction first indicated when said assist mode is selected is the first rotational direction.

According to the construction described above, since the rotational direction of the motor generator can be switched to alternately switch the direction of the assisted running between the forward direction and the backward direction each time the push button of the rotational direction switch is pushed, the running direction can be easily switched. In addition, since the vehicle can be moved forward without starting the engine in the assisted operation, the assisted operation can be facilitated.

(18) Eighteenth Aspect

An eighteenth aspect of the present invention is applied to the seventeenth aspect of the present invention. According to this aspect, said mode selection switch has first to third positions and is configured to switch from the first position to the third position via a second position and from the third position to the first position via the second position and to assume said first position to select said normal operation mode, assume said second position to select the engine stop mode, and assume said third position to select the assist mode.

(19) Nineteenth Aspect

A nineteenth aspect of the present invention is applied to the seventeenth or eighteenth aspect of the present invention. According to this aspect, in the motorcycle described in the seventeenth or eighteenth aspect of the present invention, the push button switch forming said rotational direction switch serves also as a push button switch that is pushed to generate said engine stop command.

Since the engine is not started during the assisted operation, using the engine starter switch, which is pushed to start the engine, as the rotational direction switch does not pose any problem. According to this construction, the number of switches can be reduced, so that manipulations can be prevented from being complicated.

(20) Twentieth Aspect

A twentieth aspect of the present invention is applied to the fifteenth or eighteenth aspect of the present invention. According to this aspect, said mode selection switch serves also as a kill switch that generates said engine stop command when said engine is to be forcedly stopped, and when said mode selection switch is used as the kill switch, said first position is used as a position to allow a rotation of said engine, and said second position and said third position are used as positions to generate said engine stop command.

A motorcycle is provided with a switch to forcedly stop the engine in order to enable emergency stop of the engine anytime. The switch is referred to as a kill switch. A typical kill switch is a two-position switch that assumes two positions, a position to allow a rotation of the engine to enable a normal running (ON position) and a position to generate an engine stop command to forcedly stop the engine (OFF position). In the present invention, since the three-position switch used as the mode selection switch is used also as the kill switch, the first position is used as a position to allow a rotation of the engine, and the second and third positions are used as positions to generate an engine stop command. According to this construction, the number of switches can be reduced, and the construction can be simplified.

(21) Twenty-First Aspect

A twenty-first aspect of the present invention is applied to any one of the first to twentieth aspects of the present invention. According to this aspect, said sub-clutch is comprised of a dog clutch that is turned on and off by an actuator electrically driven.

The dog clutch is a clutch used to select from among or switch between gears of a transmission of a motorcycle, has a small size and a simple structure, and is inexpensive.

What is claimed is:

1. A motorcycle, comprising:
an engine;
an engine controlling section that controls said engine; and
a power transmission device that has a main clutch turned on and off during running and transmits a rotation of said engine to a driving wheel when the main clutch is in an on state, said engine controlling section being configured to stop said engine when an engine stop command is provided thereto,
the motorcycle further comprising:
a sub-clutch that is inserted between an output shaft of said engine and said power transmission device and is capable of being controlled to be on and off;
a motor generator that is comprised of a dynamo electric machine functioning as a motor and a generator and has a rotating shaft coupled to said power transmission device in such a manner that the rotating shaft is coupled to the output shaft of said engine via said sub-clutch and coupled to said driving wheel via said main clutch;
a mode selection switch that selects a normal operation mode that allows a normal operation using said engine as a power source, an engine stop mode, or an assist mode that allows an assisted operation using said motor generator as a power source; and
a processor that performs a generation or cancellation of said engine stop command and a control of said sub-clutch and said motor generator according to the mode selected by said mode selection switch,
said processor being configured to:
(a) generate said engine stop command when said engine stop mode or said assist mode is selected and control generation and cancellation of said engine stop command so as to cancel said engine stop command when said normal operation mode is selected;
(b) control said sub-clutch in such a manner that said sub-clutch is turned on when a mode other than said assist mode is selected and turned off when said assist mode is selected; and
(c) perform an assisting motor control to control said motor generator to operate as a motor when said assist mode is selected.

2. The motorcycle according to claim 1, wherein said processor is configured to perform an engine starting motor control to control said motor generator to operate as a motor when an engine start command is provided thereto when said normal operation mode is selected.

3. The motorcycle according to claim 1, wherein said processor is configured to gradually increase a rotational speed of said motor generator to a preset rotational speed when said assisting motor control is performed.

4. The motorcycle according to claim 1, further comprising:
a throttle sensor that detects the amount of manipulation of a throttle manipulated to adjust a rotational speed of said engine,
wherein said processor is configured to change a rotational speed of said motor generator according to the amount of manipulation of the throttle detected by said throttle sensor within a range that does not exceed a preset rotational speed when said assisting motor control is performed.

5. The motorcycle according to claim 3, wherein said preset rotational speed is set so that an upper limit of a vehicle speed falls within a range of 2 to 3 km/h.

6. The motorcycle according to claim 1, further comprising:
a vehicle speed sensor that detects a vehicle speed,
wherein said processor is configured to gradually increase the vehicle speed detected by said vehicle speed sensor to a preset limit speed when said assisting motor control is performed.

7. The motorcycle according to claim 6, wherein an upper limit of said vehicle speed is set to fall within a range of 2 to 3 km/h.

8. The motorcycle according to claim 1, wherein said processor is configured to start said assisting motor control on the condition that a driver is performing an operation of turning off said main clutch.

9. The motorcycle according to claim 1, wherein said processor is configured to perform said assisting motor control only when a transmission in said power transmission device is set in a first speed gear position.

10. The motorcycle according to claim 3, further comprising:
a gear position sensor that detects a gear position of a transmission in said power transmission device,
wherein said processor is configured to switch the preset rotational speed according to the gear position detected by said gear position sensor.

11. The motorcycle according to claim 1, wherein said processor is configured to stop operation of said motor generator as a motor when an operation of a brake by a driver is detected when said assisting motor control is performed.

12. The motorcycle according to claim 1, further comprising:
alarm means that produces an alarm sound when said processor is performing said assisting motor control.

13. The motorcycle according to claim 1, further comprising:
falling detecting means that detects whether the motorcycle is in a fallen state or not,
wherein said processor is configured to stop said assisting motor control when said falling detecting means detects a falling.

14. The motorcycle according to claim 1, wherein said processor is configured to rotate said motor generator only in a direction to move the motorcycle backward when said assisting motor control is performed.

15. The motorcycle according to claim 1, wherein said mode selection switch has first to third positions and is configured to switch from the first position to the third position via a second position and from the third position to the first position via the second position and to assume said first position to select said normal operation mode, assume said second position to select the engine stop mode, and assume said third position to select the assist mode.

16. The motorcycle according to claim 2, wherein said processor is configured to control said motor generator so as to rotate said motor generator in a rotational direction at the time of start of the engine when said engine starting motor control is performed and to rotate said motor generator in a rotational direction corresponding to the direction of travel of the motorcycle when said assisting motor control is performed.

17. The motorcycle according to claim 16, further comprising:
a rotational direction switch that is comprised of a push button switch, a push button of the rotational direction switch being pushed to switch the rotational direction of the motor generator during said assisting motor control between a first rotational direction to move the motorcycle backward and a second rotational direction to move the motorcycle forward,
wherein said processor is configured to alternately switch the indicated rotational direction between the different directions each time the push button of said rotational direction switch is pushed on the assumption that the rotational direction first indicated when said assist mode is selected is the first rotational direction.

18. The motorcycle according to claim 17, wherein said mode selection switch has first to third positions and is configured to switch from the first position to the third position via a second position and from the third position to the first position via the second position and to assume said first position to select said normal operation mode, assume said second position to select the engine stop mode, and assume said third position to select the assist mode.

19. The motorcycle according to claim 17, wherein the push button switch forming said rotational direction switch serves also as a push button switch that is pushed to generate said engine stop command.

20. The motorcycle according to claim 15, wherein said mode selection switch serves also as a kill switch that generates said engine stop command when said engine is to be forcedly stopped, and when said mode selection switch is used as the kill switch, said first position is used as a position to allow a rotation of said engine, and said second position and said third position are used as positions to generate said engine stop command.
